(19) United States
(12) Patent Application Publication
(10) Pub. No.: US 2005/0137903 A1
(43) Pub. Date: Jun. 23, 2005

(54) Client management system for social service organizations

(76) Inventors: James Storms, Farmington, MN (US); Gerard A. Lauer, St. Paul, MN (US)

Correspondence Address: SHUMAKER & SIEFFERT, P. A., 8425 SEASONS PARKWAY, SUITE 105, ST. PAUL, MN, 55125, US

(21) Appl. No.: 10/815,101

(22) Filed: Mar. 31, 2004

Related U.S. Application Data
(60) Provisional application No. 60/466,496, filed on Apr. 29, 2003.

(51) Int. Cl. G06F 17/60

(52) U.S. Cl. 705/1

(57) ABSTRACT

The invention is directed to a client management system for social service organizations. The client management system provides a powerful, convenient, and easy-to-use system for management of client relationships within a social service organization. The client management system may be useful in a variety of social service organizations including, for example, homeless shelters, domestic violence support providers, state and country governments, information and referral agencies, and food shelves. The client management system may facilitate client intake, delivery of services, case management, data sharing among different organizations or facilities within a single organization, security monitoring, and custom reporting.

This application claims the benefit of U.S. Provisional Application Ser. No. 60/466,496, filed Apr. 29, 2003, the entire content of which is incorporated herein by reference.

### TECHNICAL FIELD

This invention relates to delivery of social services and, more particularly, to client management tools for social services organizations.

### BACKGROUND

Social service organizations, such as homeless shelters, domestic violence support providers, state and country governments, information and referral agencies, and food shelves, deliver a variety of social services to clients in need. Some social services clients can be itinerant, and may seek services from more than one social service organization, or more than one facility within a single social service organization. In addition, some clients may use social services on an infrequent or erratic basis. In some instances, social services organizations can encounter security or other safety risks in the course of serving particular clients. In view of these and other factors, management of the relationships between one or more social services organizations and their clients can be difficult.

### SUMMARY

The invention is directed to a client management system for social service organizations. In addition, the invention is directed to methods that may be implemented by a client management system.

The client management system provides a powerful, convenient, and easy-to-use system for management of client relationships within a social service organization. The client management system may be useful in a variety of social service organizations including, for example, homeless shelters, domestic violence support providers, state and country governments, information and referral agencies, and food shelves.

The client management system may facilitate client intake, delivery of services, case management, data sharing among different organizations or facilities within a single organization, security monitoring, and custom reporting. In some embodiments, for example, the client management system may support controlled access to facilities such as homeless shelters, and enable verification of admission of individuals to a shelter.

The client management system may utilize client credentials, such as identification cards, fobs, tags, keys, or other media carrying information that identifies a client. An identification card, for example, may carry human-readable information such as a photo, name and other client information, as well as machine-readable information encoded in a data carrying medium such as a magnetic stripe, bar code, radio frequency identification tag, or smartcard chip.

When a client seeks access to a facility, the client management system reads the client credentials and queries a database. The database may store a variety of client information such as information concerning intake dates, family information, services provided, observation histories, incident histories and the like. The client management system may use the information stored in the database to recommend a course of action for social service organization personnel.

For example, upon presentation of the client credentials, the client management system may invoke an incident/observation tracking module to determine whether the database indicates any security or safety incidents for the client. If so, the client management system may generate an advisory to refuse admission to the client.

In addition, in a homeless shelter, the client management system may invoke a housing module to track applications for and usage of housing by clients. For example, the housing module may track government-sponsored housing contracts, such as HUD contracts, and other information relating to short-term, transition, and long-term or permanent housing. In addition, the housing module may record data about the clients who are using housing resources, enabling ready reporting and record keeping, e.g., to satisfy government regulatory requirements. Also, the housing module may record length of stay information. In some cases, the housing module may further be configured to aid in a search for housing accommodations for the client. In this case, the housing module may commence an automated workflow for matching the client with a housing opportunity.

As a further option, the client management system may invoke a direct services module that manages scheduling and allocation of services to clients. The direct services module may commence an automated workflow for delivery of selected services to the client.

Also, the client management system may provide a reporting module that supports collection, presentation and analysis of information concerning clients and utilization of services. In this manner, the social services organization can evaluate its own performance and the value of the services provided to clients.

In one embodiment, the invention is directed to a method in which a client credential card is read to identify a client of a social service organization, data associated with the identified client is retrieved from a database, and it is determined whether the identified client is permitted to receive a service provided by the social service organization based on the retrieved data.

In another embodiment, the invention is directed to a client management system that includes a database to store data associated with a client of a social service organization, a card reader to read a client credential card associated with the client, and an access workstation coupled to the card reader. The access workstation identifies the client based on data read from the client credential card, retrieves at least some of the data associated with the client from the database, and determines whether the client is permitted to receive a service provided by the social service organization based on the retrieved data.

In another embodiment, the invention is directed to a computer-readable medium comprising instructions. The instructions cause a programmable processor to identify a client of a social service organization based on data read from a client credential card, retrieve data associated with the identified client from a database, and determine whether the identified client is permitted to receive a service provided by the social service organization based on the retrieved data.

In another embodiment, the invention is directed to a method in which data associated with clients of at least one social service organization is collected, the data for each of the clients including identification data, a record is created within a database for each of the clients, each of the records including at least some of the data collected for the respective client, and a client credential card is generated for each of the clients, wherein each of the client credential cards includes at least a portion of the data for the respective client. The method further includes reading the client credential cards to identify clients when the clients attempt to receive services provided by the social service organization, and updating the records within the database based on services received by the clients to track usage of the services by the clients.

In another embodiment, the invention is directed to a client management system including a database, an intake workstation, and an access workstation. The intake workstation collects data associated with clients of at least one social services organization, the data for each of the clients including identification data, creates a record within the database for each of the clients, each of the records including at least some of the data collected for the respective client, and controls a card printer-to generate a client credential card for each of the clients, wherein each of the client credential cards includes at least a portion of the data for the respective client. The access workstation reads the client credential cards via a card reader to identify clients when the clients attempt to receive services provided by the social service organization, and updates the records within the database based on social services accessed by the clients provided by the social service organization to track usage of the services by the clients.

The invention may provide a number of advantages. In general, the client management system can help a social service organization to more accurately track the clients who uses its services. With this enhanced tracking capability, the social service organization can more efficiently and effectively deliver services to its clients. In addition, the social service organization may be able to reduce safety and security risks by recording incidents involving particular client and quickly verifying the presence of an individual client within a facility should the need arise. Also, the client management system may be configured for sharing of information among multiple facilities or social service organizations. As another advantage, the client management system may support automation of various activities, including delivery of direct services and housing services. Further, the reporting capability provided by the client management system can serve as a powerful tool in performance and value analysis.

The details of one or more embodiments are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating a client intake system forming part of a client management system for a social services organization.

FIG. 2 is a front view of a client credential card produced by the client intake system of FIG. 1.

FIG. 3 is a back view of a client credential card produced by the client intake system of FIG. 1.

FIG. 4 is a block diagram illustrating a client access system forming part of the client management system for a social services organization.

FIG. 5 is a block diagram illustrating implementation of the client management system on a shared basis among multiple facilities or social services organizations.

FIG. 6 is a block diagram illustrating modules running on the client access workstation shown in FIG. 4.

FIG. 7 is a flow diagram illustrating a client intake process within the client management system.

FIG. 8 is a flow diagram illustrating a client access process within the client management system.

FIG. 9 illustrates an example client tracking screen presented by the client management system.

FIGS. 10 and 11 illustrate example client record screens presented by the client management system.

FIG. 12 illustrates an example client facility access record screen presented by the client management system.

FIG. 13 illustrates an example housing intake screen presented by the client management system.

FIG. 14 illustrates an example services screen presented by the client management system.

FIG. 15 illustrates an example behavioral report screen presented by the client management system.

FIG. 16 illustrates an example report generator screen presented by the client management system.

FIG. 17 illustrates an example report screen presented by the client management system.

FIGS. 18-23 illustrate example client data intake screens presented by the client management system.

### DETAILED DESCRIPTION

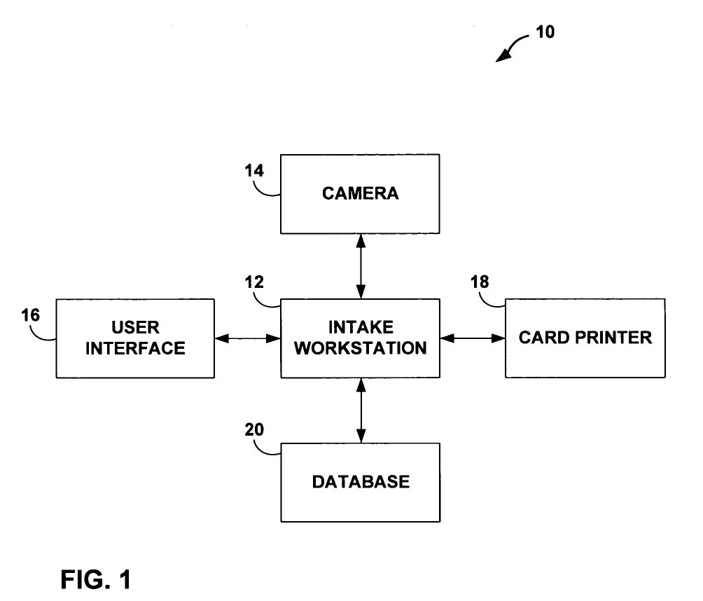

FIG. 1 is a block diagram illustrating a client intake system 10 forming part of a client management system for a social services organization in accordance with the invention. As shown in FIG. 1, system 10 may include an intake workstation 12, a camera 14, a user interface 16, a card printer 18 and a database 20. Client intake system 10 collects client information and generates client credential cards to be carried by clients. Client intake system 10 may be installed near an entrance to a social service organization facility for processing of new clients.

Intake workstation 12 may take the form of a personal computer or computer workstation. User interface 16 may include a display, keyboard, pointing device and the like. Camera 14 may take the form of a digital camera that captures a digital photo of a client and transmits the photo to intake workstation 12, e.g., via a USB interface or removable media reader. Card printer 18 may take the form of a conventional card printing system, and may produce single layer printed cards or laminated cards.

Database 20 may take a variety of forms, and may store data within in any type of data structure, including a relational data structure. In one embodiment, database 20 may be realized by Lotus Notes database. In this case, database 20 may include a Lotus Domino server running on server platform, such as an IBM AS400 server running the OS/400 operating system. Intake workstation 12 may run a version of Lotus Notes, and access database 20 via a network connection. An intake software application may be loaded onto intake workstation 12 to drive collection of client data via user interface 16.

The intake software application may be implemented as a Lotus Notes application. A card generation application running on workstation 12 drives printing of client credential cards via card printer 18. An example of a suitable card generation application is the IDWorks software application commercially available from Datacard Corporation of Minneapolis, Minn. The card generation application may collect data from the Lotus Notes application or records within database 20 to place within fields in client credential cards printed by card printer 18. The reference to particular software applications and database platforms herein is for purposes of illustration and should not be considered limiting of the invention.

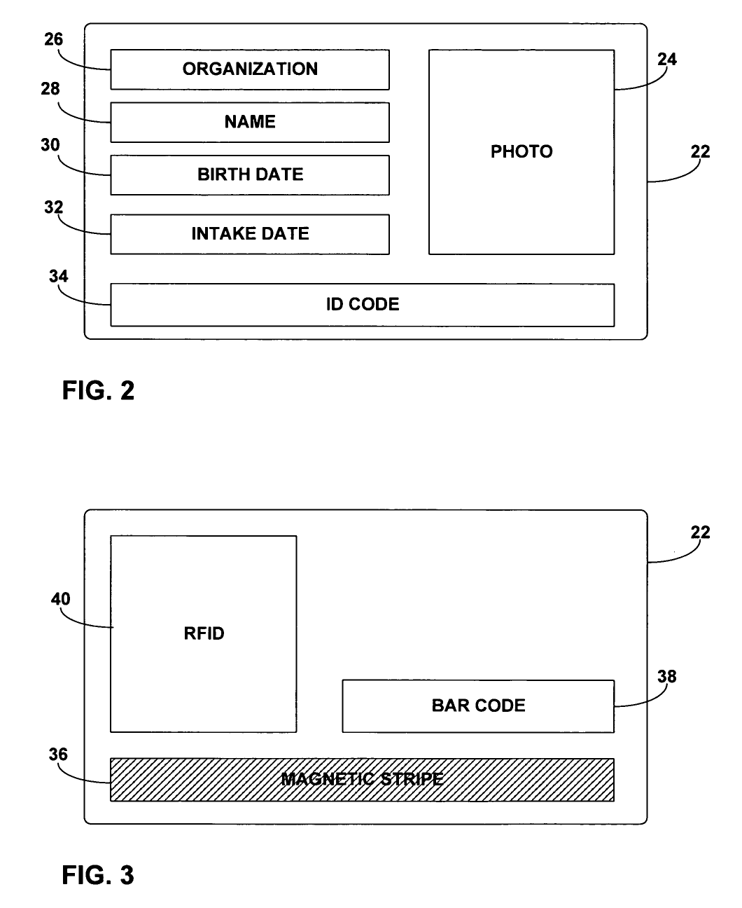

FIG. 2 is a front view of a client credential card 22 produced by client intake system 10 of FIG. 1. In the example of FIG. 2, client credential card 22 includes a client photo 24, an organization field 26, a name field 28, a birth date field 30, and intake date field 32 and an identification code 34. Photo 24 includes a photo obtained by camera 14 (FIG. 1). Organization field 26 contains the name of the pertinent social services organization. Name field 28 contains the name of the client. Birth date field 30 contains the birth date of the client. Intake date field 32 contains the date the client was first processed for intake by the social services organization. Identification code 34 may be an alphanumeric code that uniquely identifies the client. The information on the front side of client credential card 22 may be, in general, human-readable.

FIG. 3 is a back view of client credential card 22 produced by client intake system 10 of FIG. 1. In the example of FIG. 3, client credential card 22 includes a magnetic stripe 36 that magnetically encodes information in a machine-readable format. As further options, client credential card may include a machine-readable bar code 38, an embedded radio frequency identification (RFID) tag 40, or a smartcard chip (not shown). The machine-readable information encoded in magnetic stripe 36, bar code 38 and RFID tag 40 may present some or all of the information presented in human-readable form on the front side of client credential card 22, and may include additional information not presented in human-readable form on the front side of the card. Client credential card 22 may be formed from plastic or other conventional materials typically used for identification cards.

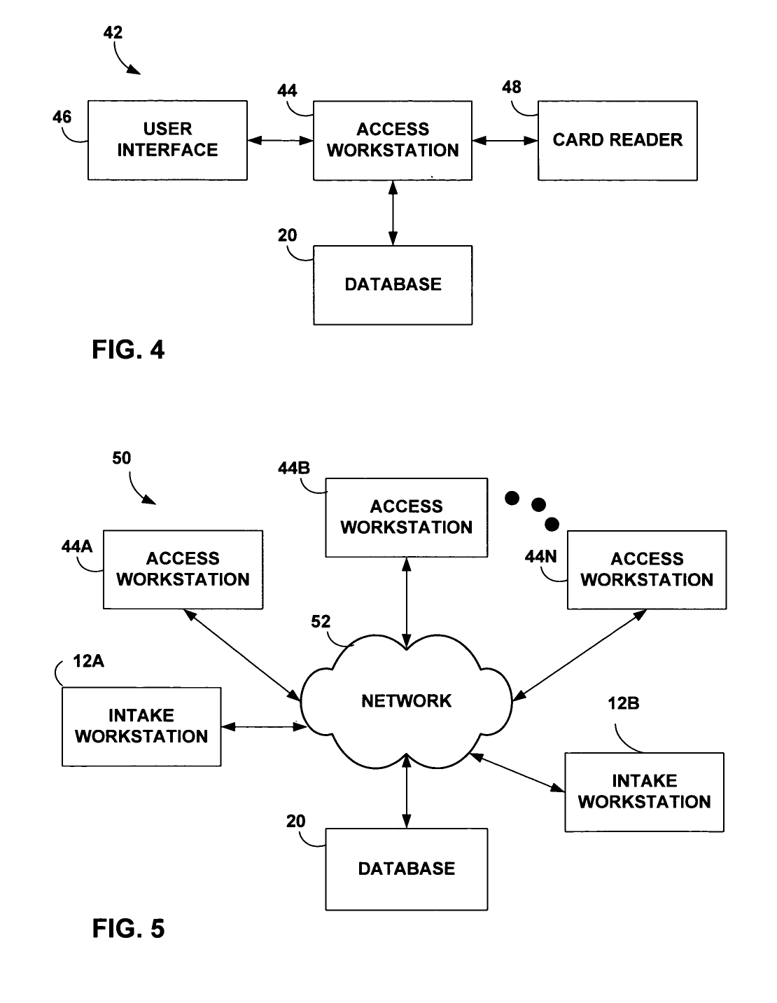

FIG. 4 is a block diagram illustrating a client access system 42 forming part of the client management system for a social services organization in accordance with the invention. As shown in FIG. 4, client access system 42 may include an access workstation 44, a user interface 46, a card reader 48, and database 20. Client access system 42 may be located near an entrance to a social service organization facility to process existing clients for access and admission to services.

Access workstation 44 may take the form of a personal computer or computer workstation. User interface 46 may include a display, keyboard, pointing device and the like. Card reader 48 may be a magnetic stripe reader, bar code reader, RFID reader, or the like. Facility personnel may inspect human-readable information printed on a client credential card 22. Card reader 48 reads the machine-readable information carried by client credential card 22.

In response to the information obtained by card reader 48, access workstation 44 queries database 20 for additional information associated with the client. Like intake workstation 12, access workstation 44 may run a database application, such as Lotus Notes, to access database 20. As will be described, access workstation 44 may run processes that facilitate delivery of services to clients, security and safety monitoring, and reporting and analysis of organizational statistics. Advantageously, the Lotus Notes platform also may support an automated workflow to generate and send forms, emails, and other messages associated with an intake, services, security or housing activity.

FIG. 5 is a block diagram illustrating implementation of a client management system 50 on a shared basis among multiple facilities or social services organizations. As shown in FIG. 5, multiple access workstations 44A-44N (hereinafter 44) and intake workstations 12A and 12B (hereinafter 12) may access a common database 20 via a network 52. Network 52 may be any network, and may include one or more of a local area network (LAN), the Internet, the Public Switched Telephone Network (PTSN), or a wireless communication network.

Each of intake workstations 12 may have full or limited access to database 20 to create new client records. Further, each of access workstations 44 may have full or limited access to the records stored in common database 20 to read information from database 20, and to modify the contents of records within the database. With shared access to a common database 20, multiple facilities within a given social service organization or multiple social service organizations can exchange information concerning individual clients to enhance overall services, minimize security and safety risks, or report and analyze overall service delivery and client statistics.

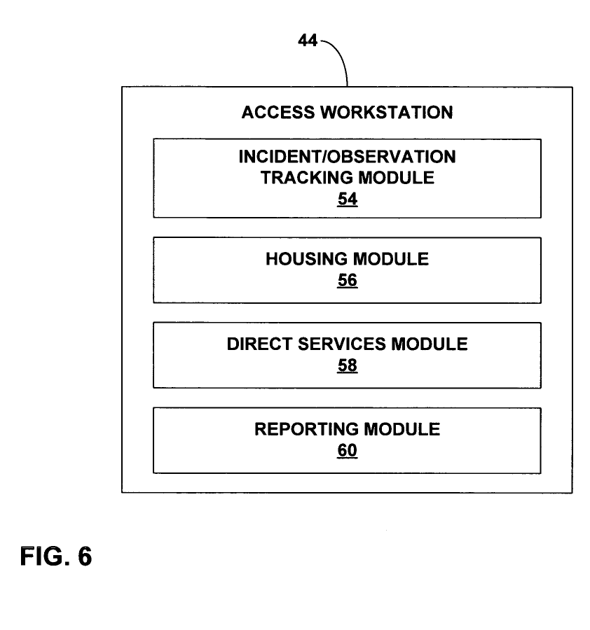

FIG. 6 is a block diagram illustrating exemplary modules running on client access workstation 44 shown in FIG. 4. As shown in FIG. 6, client access workstation 44 includes an incident/observation tracking module 54, a housing module 56, a direct services module 58, and a reporting module 60.

Incident/observation tracking module 54, upon identification of a particular client, queries database 20 for information concerning past incidents or observations involving the client. A record of previous incidents or observations may serve to identify client that pose a safety or security risk. An incident, for example, may refer to a past event involving violent or hostile behavior by the client, or perhaps criminal activity. An observation may refer to notes recorded by facility personnel concerning suspicious or questionable activity by the client. In each case, retrieval of information from database 20 concerning a prior incident or observation may serve as a warning to increase security. In one embodiment, access to a facility is denied based on incidents or observations recorded within database 20

In some embodiments, incident/observation tracking module 54 may be configured to generate a security advisory on an automated basis. In addition, incident/observation tracking module 54 may present an interface for facility personnel to enter information concerning new incidents or observations. In a shared arrangement as shown in FIG. 5, multiple facilities or multiple organizations may have access to such information. As a further feature, incident/observation tracking module 54 may permit immediate verification of whether a particular client has been granted access and is on the premises of a facility. This feature may be useful when a security or safety risk is identified, e.g., by law enforcement, after admission of the client to the facility.

Housing module 56 tracks application for and usage of housing by clients. For example, the housing module may track government-sponsored housing contracts, such as HUD contracts, and other information relating to short-term, transition, and long-term or permanent housing, and store the information in database 20. In addition, housing module 56 may record data about the clients who are using housing resources in database 20, enabling ready reporting and record keeping, e.g., to satisfy government regulatory requirements. Also, the housing module 56 may record length of stay information. In some embodiments, housing module 56 also may query database 20 for housing opportunities that may be available to the client. The housing opportunities may be presented, for example, when the present facility, e.g., a homeless shelter, is fully booked and has no available space. In this case, the database 20 may be loaded with housing opportunities at other facilities in a local area, and may take advantage of a shared arrangement as shown in FIG. 5.

Alternatively, housing module 56 may be configured to identify permanent or longer-term housing opportunities, such as low income or subsidized apartments and the like. Housing module 56 may identify appropriate housing opportunities based on location and demographic information associated with the client, such as gender, age, ability, family situation or the like. Housing module 56 may be configured to automatically commence one or more workflow items necessary to secure housing such as generation of housing application forms, generation of emails to appropriate housing decision makers, and the like.

Direct services module 58 may query database 20 for a services history for the particular client. Based on the services history, facility personnel may determine whether delivery of additional services is necessary or timely. In this case, direct services module 58 may present an interface for entry of service requests, including scheduling options. In some embodiments, direct services module 58 may automatically commence one or more workflow items for delivery of services, such as scheduling of particular services, ordering of supplies for delivery of the services, and the like. Examples of particular direct services that may be provided to clients include food shelf access, telephone access, first aid, showers, storage, mail services, distribution of furniture vouchers, bus tokens, diapers and formula, and referrals to other facilities or organizations. Other services arranged by the facility may include health care and employment counseling.

Reporting module 60 may be responsive to entries made by facility personnel via a reporting interface. For example, the facility personnel may request reporting of statistics for particular clients, groups of clients, particular services, and the like. In response, reporting module 60 retrieves pertinent data from database 20, and renders one or more reports based on the data. In this manner, reporting module 60 supports collection, presentation and analysis of information concerning clients and utilization of services. Facility personnel can analyze the reports and evaluate a variety of facility or organizational characteristics, such as performance and value of the services provided to clients. This type of analysis may be important not only for operational efficiency, but also justification for state and federal funding of services. Further, this analysis may enable ready reporting and record keeping to satisfy government regulatory requirements.

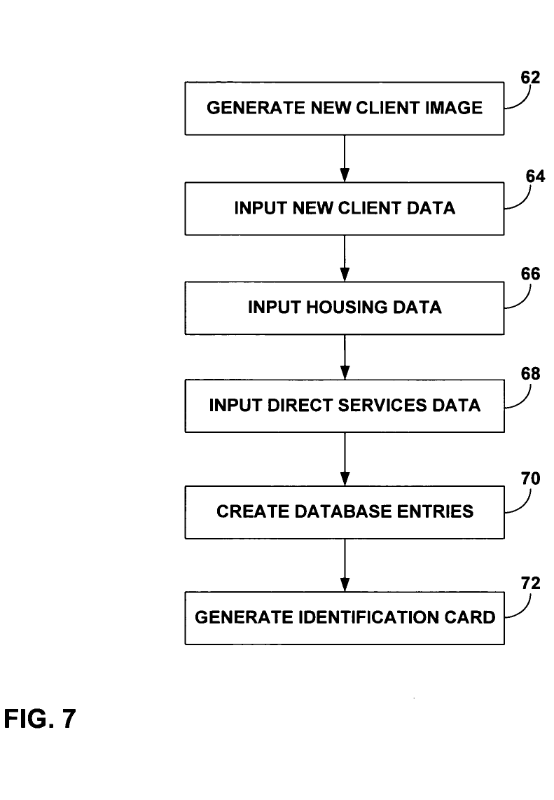

FIG. 7 is a flow diagram illustrating a client intake process within the client management system 50. As shown in FIG. 7, the intake of a new client may involve generating an image of the new client (62), e.g., a digital photo taken by a camera 14 of an intake system 10, and inputting new client data (64) such as name, gender, birth date, height, weight, eye color, hair color, complexion, ethnicity, family contact information, and the like via a user interface 16 and an intake workstation 12. The process may further involve inputting housing data (66), such as last permanent address, and inputting direct services data (68), such as identification of particular services desired by the client via the user interface 16 and the intake workstation 12. Upon creation of entries (70) within a database 20 in accordance with the inputted data, e.g., a client record, the process further involves generating a client credential card 22 (72), e.g., by the intake workstation 12 and card printer 18.

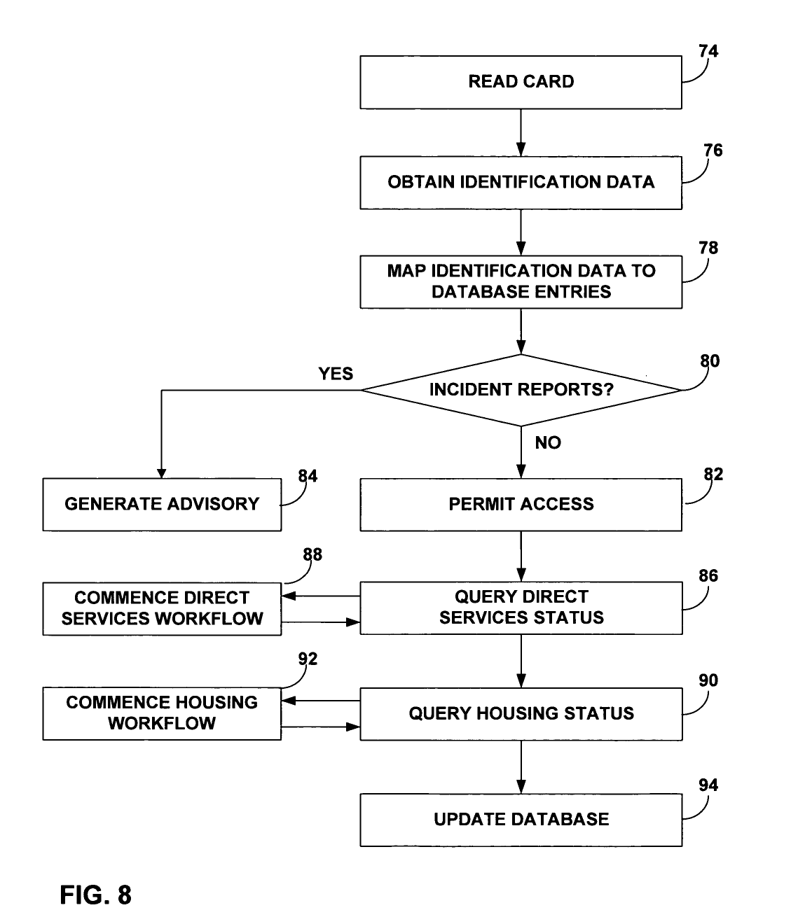

FIG. 8 is a flow diagram illustrating a client access process within the client management system 50. As shown in FIG. 8, the client access process may involve reading a client credential card 22 (74), obtaining identification data from the card 22 (76), and mapping the identification data to database entries within a database 20 (78). In some cases, a card reader 48 of an access system 42 reads machine-readable identification data from the card 22, and an access workstation 44 maps the data to entries within database 20. In other cases, a user reads human-readable identification data from the card 22, and enters the identification data into the access workstation 44 via a user interface 48 so that the access workstation may map the data to the entries.

The process may further involve querying the status of one or more modules. In one embodiment, an incident/observation tracking module queries the database 20 for any incident reports (80). In the example of FIG. 8, the access workstation 44 may generate an advisory (82) in the event an incident report is identified for the particular client. If no incident reports exist, the client is permitted to access the facility (84).

In another example, the process querying of direct services status by a direct services module 58 (86). For example, if the client is due for a particular service, the access workstation 44 may automatically commence a direct services workflow to request or schedule particular services (88). In addition, housing status may be queried by a housing module 56 (90), e.g., for space in other facilities or permanent or temporary housing. In one embodiment, access workstation 44 automatically commences a housing workflow to secure housing accommodations for the client (92).

Upon querying the status of one or more modules, database 20 may be updated (94). Specifically, a person using access workstation 44 or access workstation 44 itself may modify or update data within the database, such as data within a record of the client who is currently seeking access to the facility. As an example, the record of the client may be updated to reflect admittance to a facility and any services scheduled for or provided to the client.

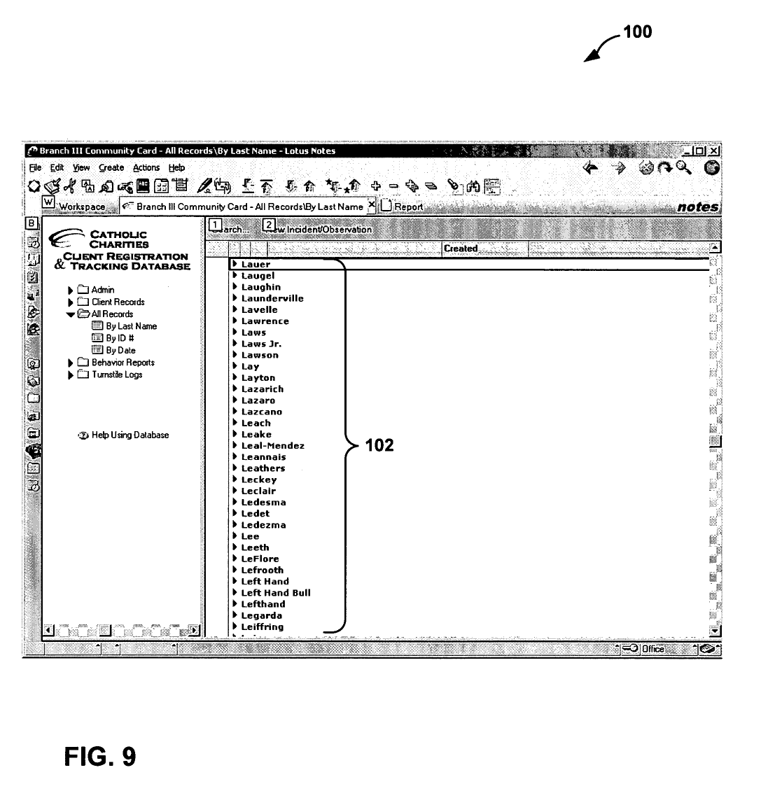

FIG. 9 illustrates an example client tracking screen 100 that may be presented by a display of a user interface 46 of an access system 42 of the client management system 50. In the example of FIG. 9, client tracking screen 100 presents a listing of client records 102. Using client tracking screen 100, facility personnel can search for individual client records within listing 102 by, for example, last name, identification number, or date, and can access the individual client records. Using client tracking screen 100, facility personnel may also access administrative information, behavior reports which may contain incident or observation reports, and turnstile logs that indicate data and time of facility access by individuals.

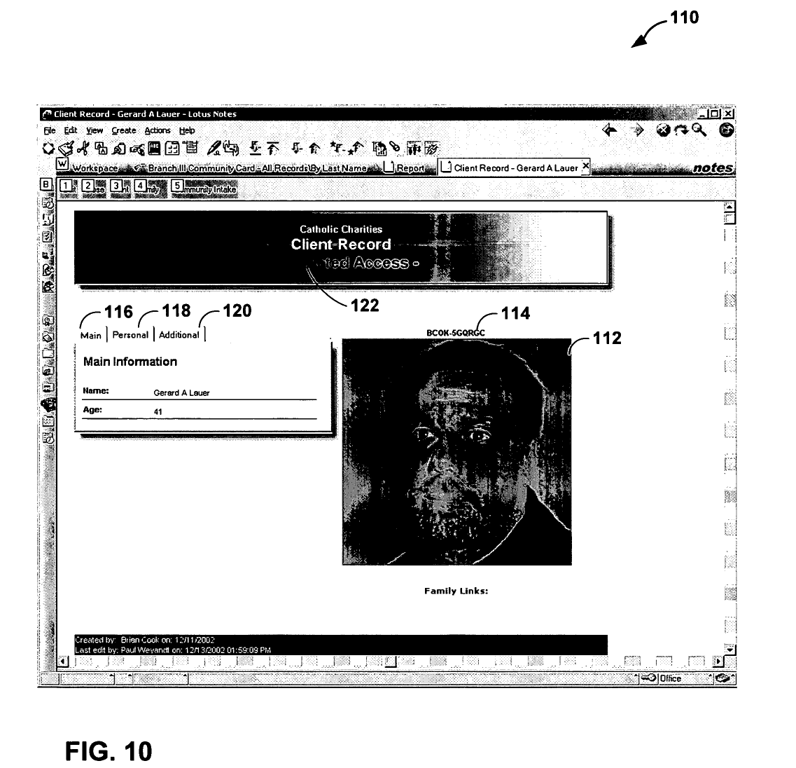

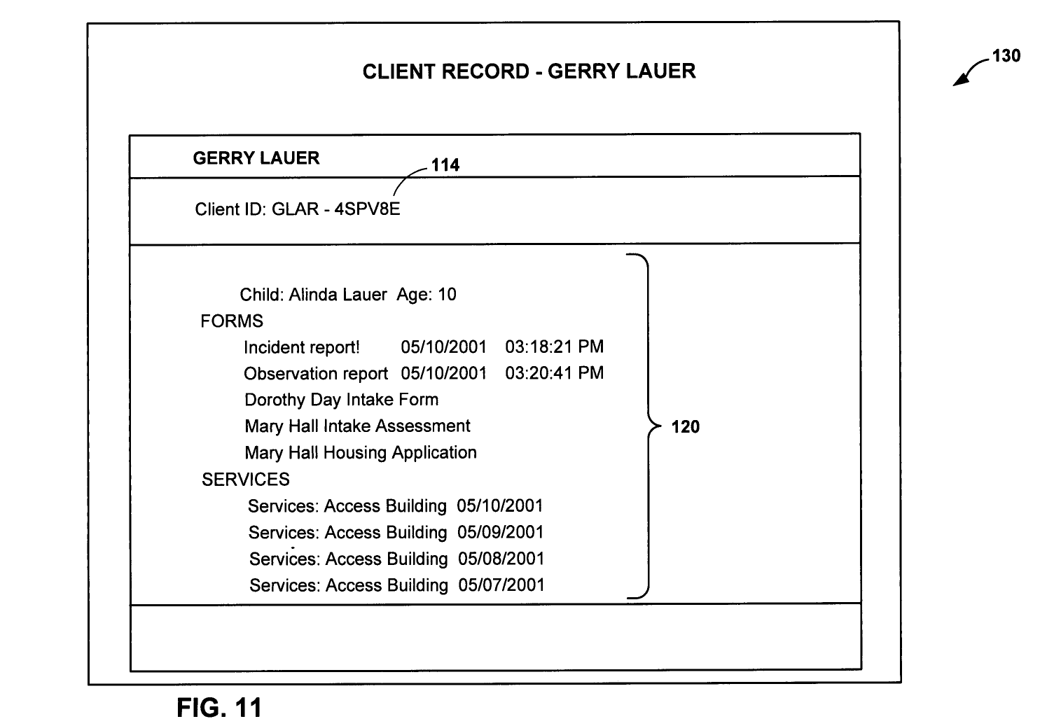

FIGS. 10 and 11 illustrate example client record screens 110 and 130 that may be presented by a display of a user interface 46 of an access system 42 of the client management system 50. In exemplary embodiments, client record screens 110 and 130 display data stored within a record stored within database 20 for a client of a social services organization, e.g., data collected and generated during an intake process as described above with reference to FIG. 7. As shown in FIG. 10, client record screen 110 may include a photo 112 of a client, a client identification code 114, and “main” information 116 for the client, such as the client's name and age. Client identification code 114 may correspond to a client identification code 34 generated during the intake process and printed on a front side of a client credential card 22.

Client record screen 110 may also present personal information 118 such as gender, birth date, height, weight, eye color, hair color, complexion, ethnicity, and the like, and additional information 120 such as family contact information. Client records may be linked with family records within database 20. For example, upon intake of a particular client, information also may be collected for children, a spouse or other dependents of the client. This information may be presented with information for the client.

In the example illustrated in FIG. 10, client record screen 110 also provides a notification 122 regarding a level of access to facilities and/or services given to the client, and indicates dates and personnel associated with creation and modification of the client record.

Client record screen 130 illustrated in FIG. 11 displays the name and identification number 114 of the client, as well as additional, additional information 120 stored within the record for the client. For example, the illustrated client record screen 130 displays information identifying children of the client, a client management forms generated for the client, and a services rendered to the client. One or both of client record screens 110 and 130 may be accessed by selecting one of the clients listed on client tracking screen 100 of FIG. 9. In some embodiments, a user accesses client record screen 130 by selection of additional information 120 within client record screen 110.

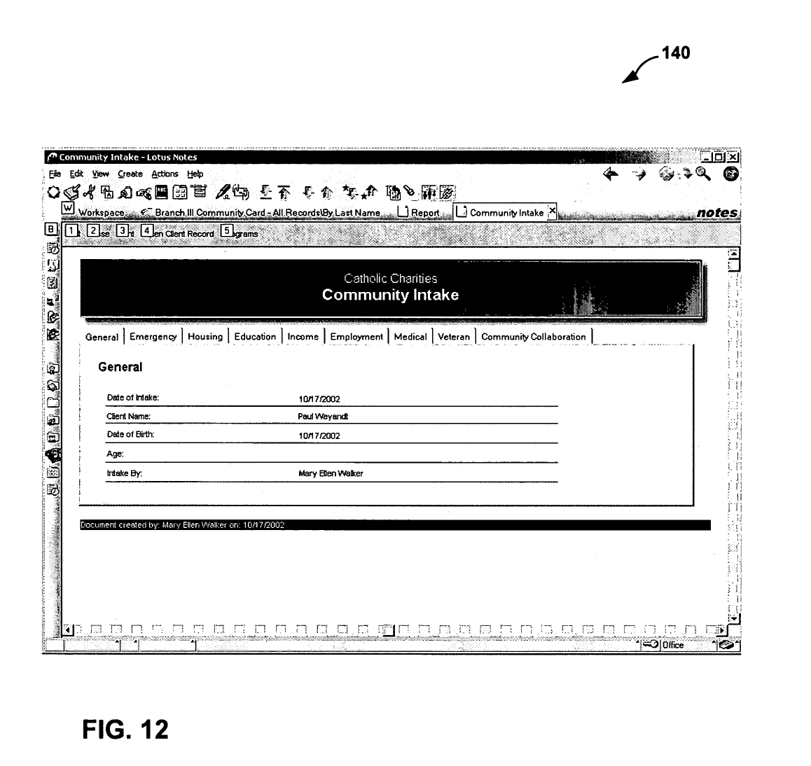

FIG. 12 illustrates an example client facility access record screen 140 that may be presented by a display of a user interface 46 of an access system 42 of the client management system 50. When a client who already has a record within database 20 and has previously been issued a card 22 attempts to access a facility for housing or other services, facility personnel may use access workstation 44 to create a facility access record reflecting admission of the client. As shown in FIG. 12, client intake screen 140 may present information concerning date of intake, client name, data of birth, age, the name of facility personnel handling intake. Additional information such as emergency contacts, housing, education, income, employment, medical data, veteran status, and community collaboration may be presented. As described above, such information about clients may be entered into database 20, where it will be stored, reviewed, modified or updated.

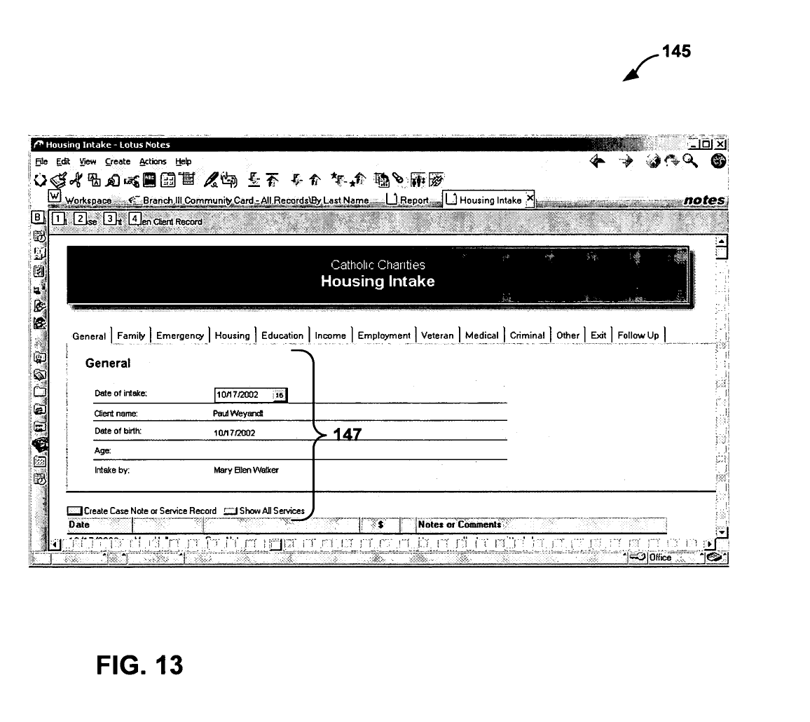

FIG. 13 is an example housing intake screen 145 presented by a display of a user interface 46 of an access system 42 of the client management system 50. As shown in FIG. 13, the housing intake screen 145 may present general information 147 such as intake date, client name, date of birth, age, and the name of facility personnel handling intake. Additional information may pertain to family, emergency contacts, housing, education, income, employment, veteran status, medical status, criminal status and the like.

Client information entered into a housing intake interface is used by housing module 56 of access workstation 44 to track application for and usage of housing by clients, and to identify housing opportunities at alternate facilities. Alternatively, client information may be used by housing module 56 to identify permanent or longer-term housing opportunities, such as low income or subsidized apartments and the like.

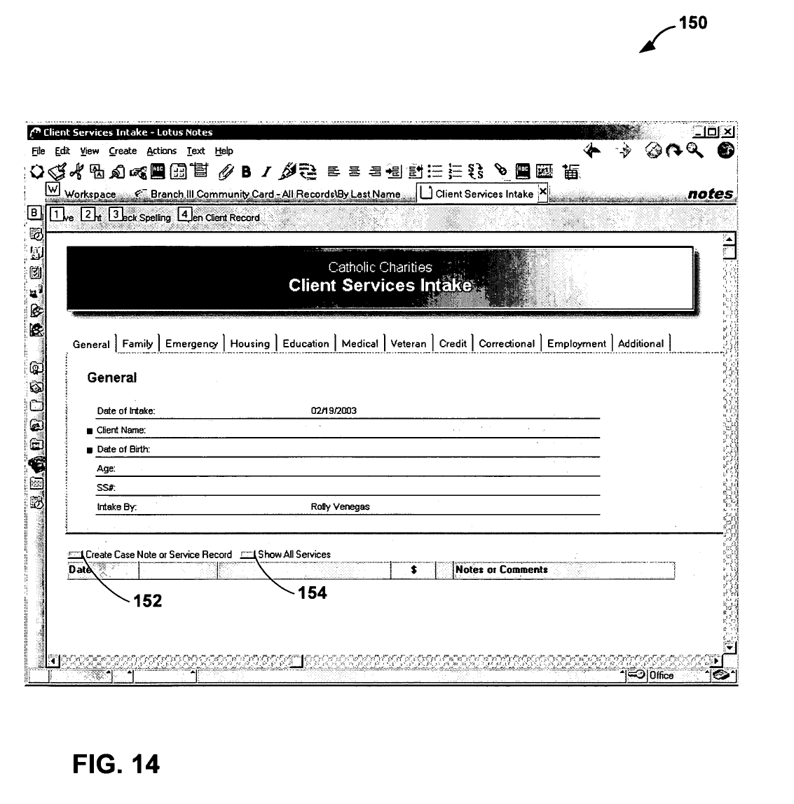

FIG. 14 is an example services screen 150 presented by a display of a user interface 46 of an access system 42 of the client management system 50. As shown in FIG. 14, the services screen 150 may include information similar to that presented in FIGS. 12 and 13. As further illustrated in FIG. 14, the services screen may present creation of case notes 152 or service records 154. Case notes 152 may include miscellaneous information about a client. Service records 154 may provide a history of the services that a client has received. The history of services that a client receives may be queried by direct services module 58 to determine whether delivery of additional services is necessary or timely.

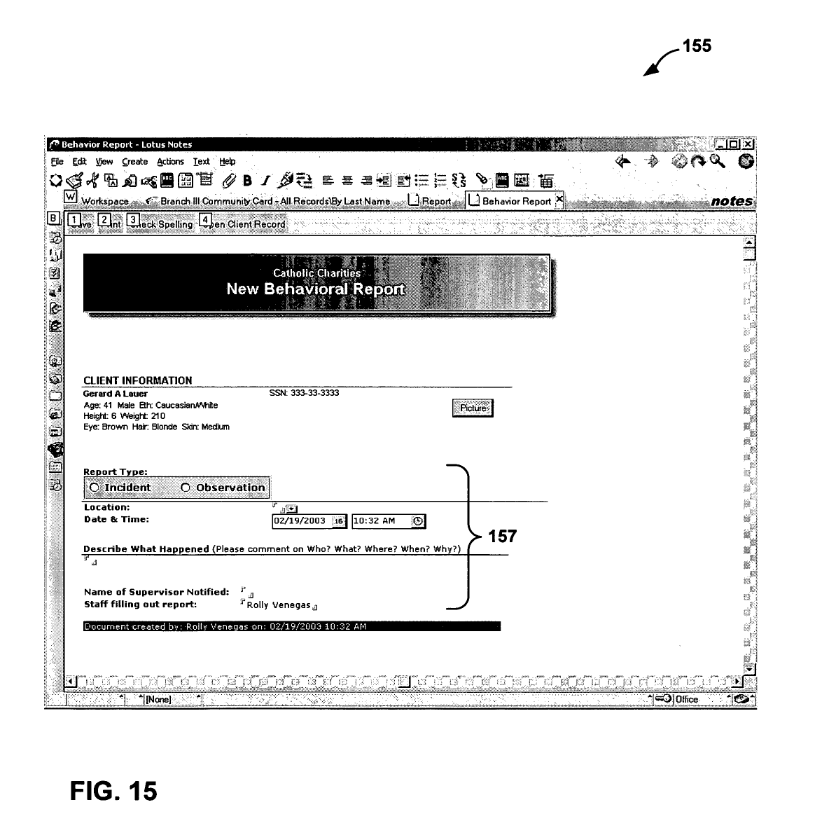

FIG. 15 illustrates an example behavioral report screen 155 that may be presented by a display of a user interface 46 of an access system 42 of the client management system 50. Behavioral report screen 155 includes fields that allow facility personnel to enter report information 157 regarding incidents or observations for a particular client, including date, time, location, and description, which may be stored within database 20 as part of the record for the client. The incidents or observations may be entered by facility personnel concerning suspicious or questionable activity by a client. The incident or observation information may also be presented by incident/observation tracking module 54, which may warn users of the client management system 50 to increase security in response to the incident or observation. In one embodiment, access is denied for the client based on incidents or observations recorded within database 20.

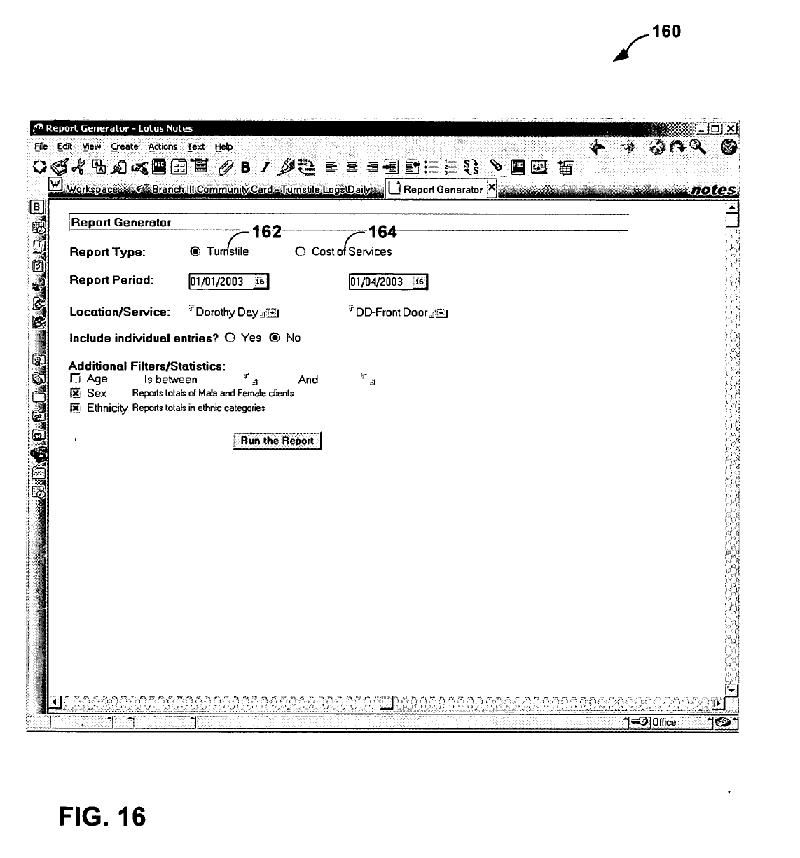

FIG. 16 illustrates an example report generator screen 160 which may be presented by the client management system 50. Report generator screen 160 may be presented by a display of a user interface 46 of an access system 42. As shown in FIG. 16, report generator screen 160 presents fields that can be selected by facility personnel to set a reporting module 60 of an access workstation 44. When run, reporting module 60 of access workstation 44 filters information contained in database 20 and produces reports such as turnstile reports 162 detailing client access to the facility, and cost of services reports 164. As described above, the reports generated by reporting module 60 may be used as evidence of compliance with regulations and as justification for funding.

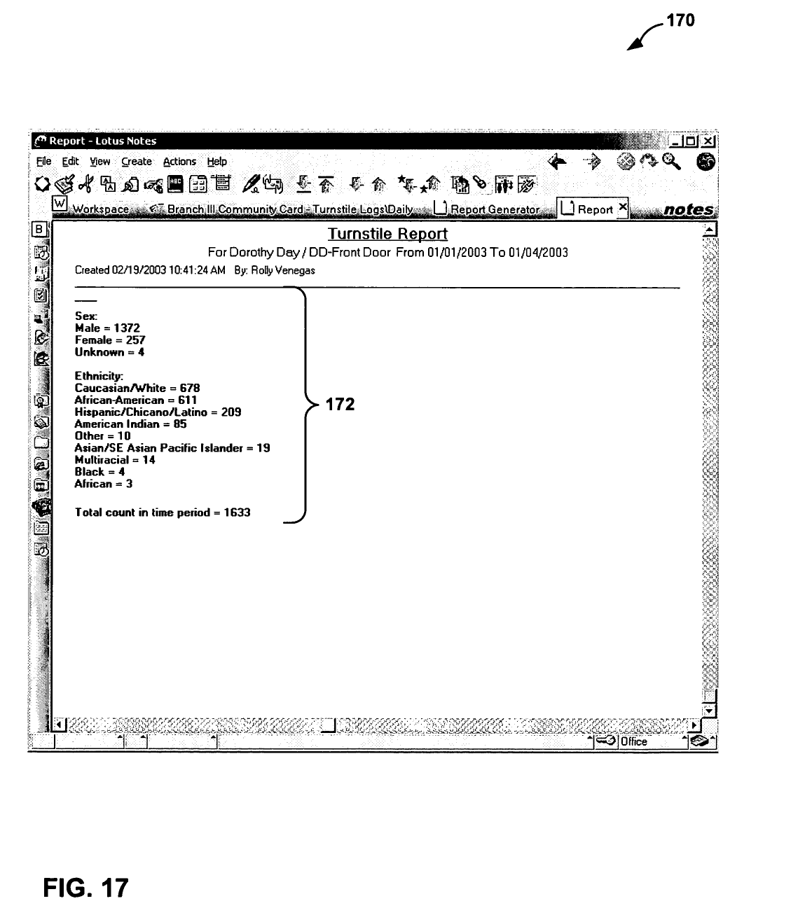

FIG. 17 illustrates an example report screen 170 presented by the client management system 50. Report screen 170 may be generated by a reporting module 60 of an access workstation 44, and may be presented by a display of a user interface 46 of an access system 42. In the example of FIG. 16, the report screen presents a turnstile report including various details for clients admitted to a facility over a period of time. In particular, the statistics 172 shown in FIG. 17 include the sex and ethnicity of clients admitted to Dorothy Day from Jan. 1, 2003 to Jan. 4, 2003.

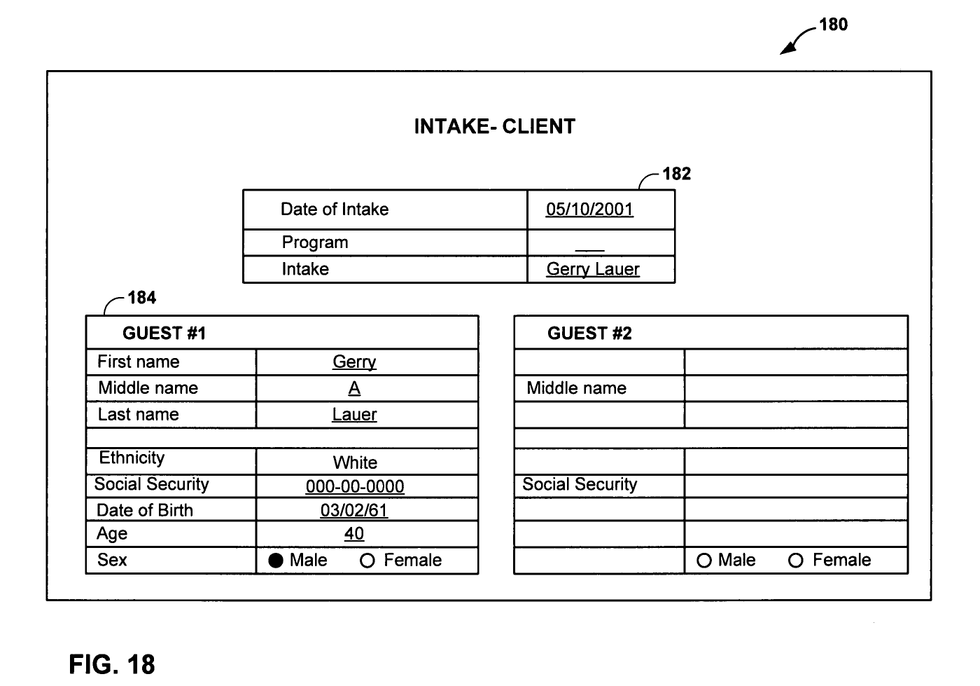

FIGS. 18-23 illustrate example client data intake screens presented by the client management system 50. The intake screens may be presented by a display of a user interface 16 of an intake workstation 12 (FIG. 1). The intake screens provide fields for entry of information by facility personnel during initial intake of a client into the client management system. The information entered may be used to create a record within database 20 and a card 22 for the client.

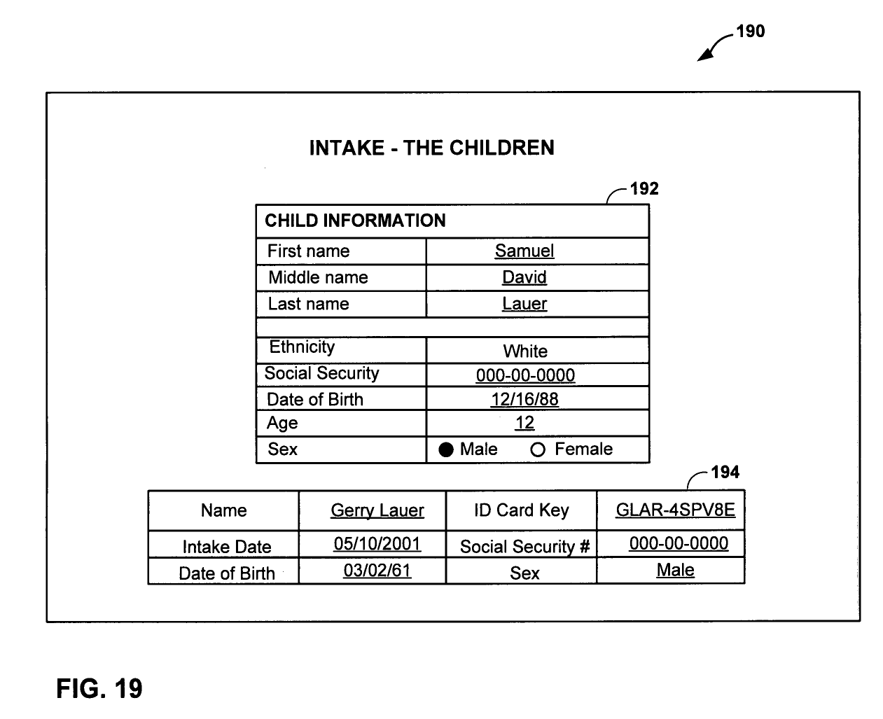

For example, FIG. 18 depicts client intake screen 180 which includes fields for entry of a variety of client information, such as main information 182 and personal information 184 that may be stored on an identification card and within a record for the client in database 20. Child intake screen 190 of FIG. 19 includes fields for entry of information 192 relating to the children of a client, as well as client information 194. Information relating to children of a client may be stored within database 20 as part of the record for the client, or within separate records that are associated with the record of the client.

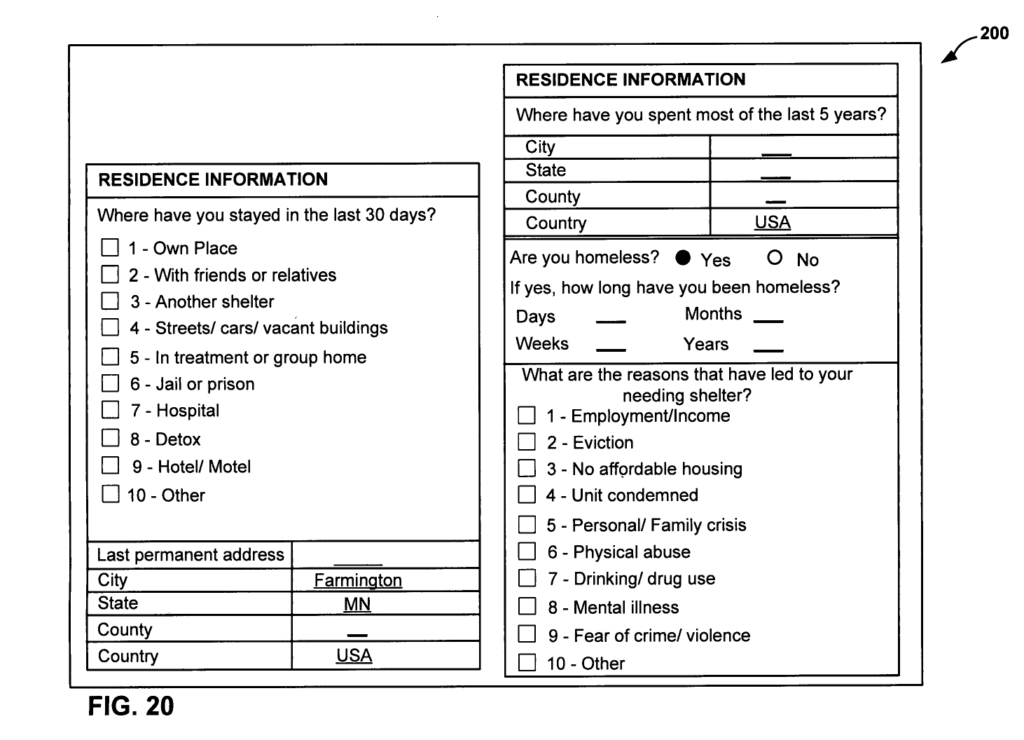

Intake screen 200 of FIG. 20 illustrates a housing intake screen 200, which includes fields for entry of information relating to the last permanent address for the client. In addition, FIG. 20 illustrates other residence information about a client, such as where the client resided over a particular period of time, where the client spent most of the last five years, and reasons that have to the client requiring shelter. Such information is stored within database 20, and may be used by, for example, a housing module 56 for preparation of applications for long-term housing, or a reporting module 60 for generation of reports that provide detail regarding the types of clients serviced by the facility or organization.

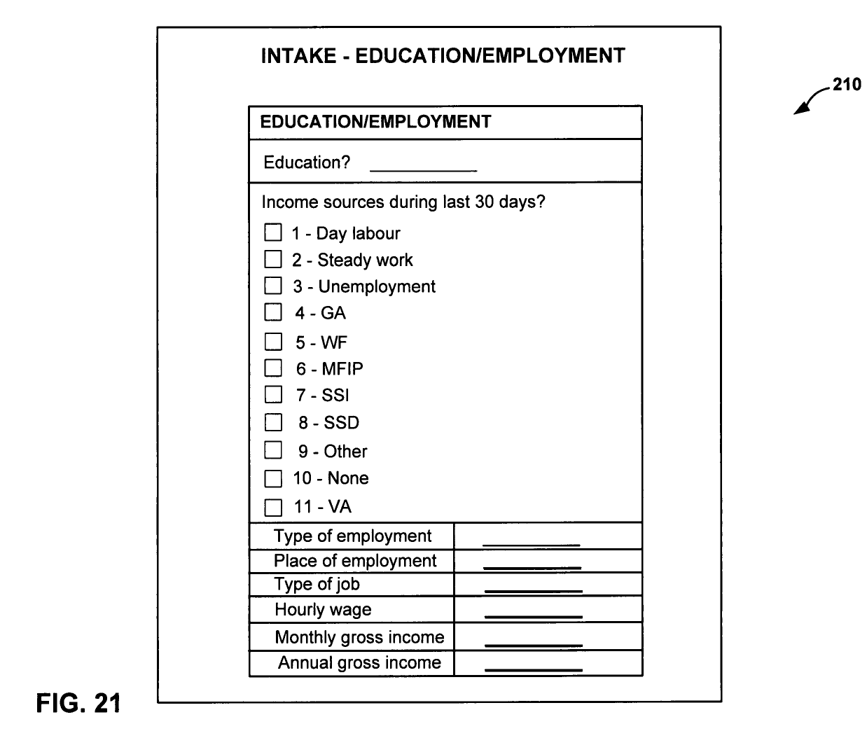

Intake screen 210 depicted in FIG. 21 includes fields for entry of client education and employment information. For example, FIG. 21 depicts a field for income sources within a particular period of time. Such information is stored within database 20, and may also be used by a housing module 56 for preparation of applications for long-term housing, a direct services module 58 for scheduling of employment related services, or a reporting module 60 for generation of reports that provide detail regarding the types of clients serviced by the facility or organization.

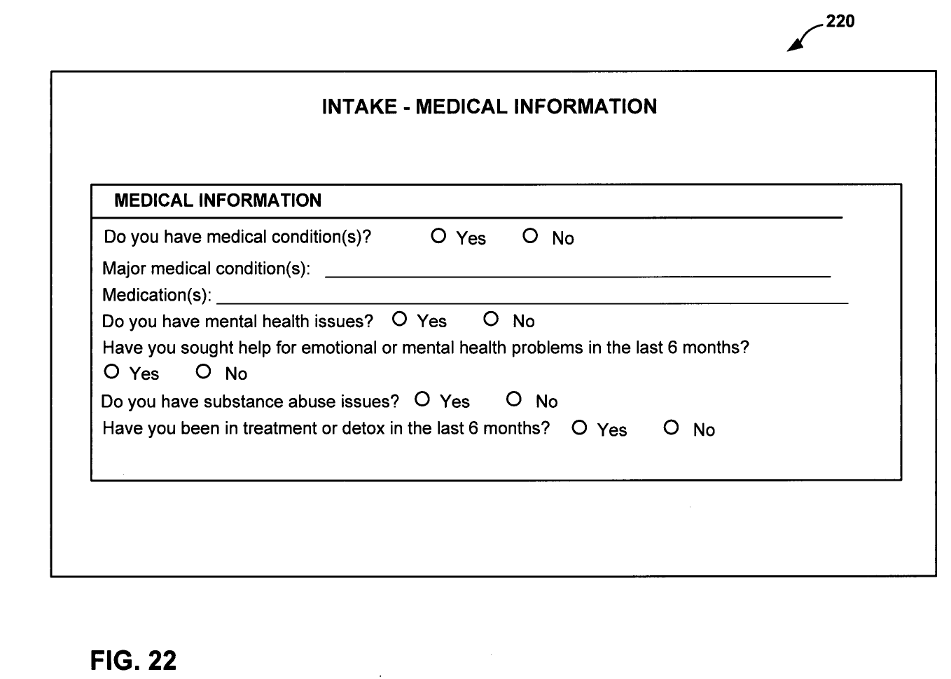

Intake screen 220 depicted in FIG. 22 includes fields for entry of client medical information. As shown, medical information may include medical conditions, mental health issues, and substance abuse issues. Such information is stored within the client record within database 20, and may be used by, for example, a direct service module 58 of a client access workstation 44 to schedule appropriate services, such as provision of medication or counseling, based on the client's condition.

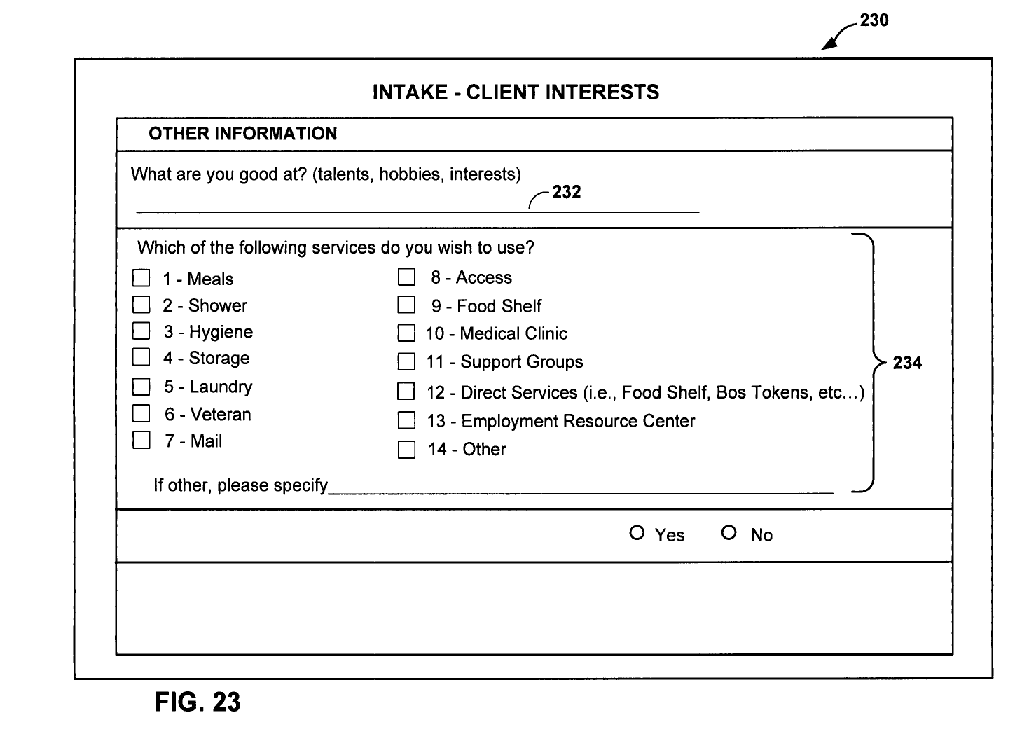

Exemplary intake screen 230 illustrated in FIG. 23 includes a field 232 for entry of client interests, and fields 234 for indicating services provided by the facility or organization that the client wishes to use. Such information may be used by a direct service module 58 of a client access workstation 44 to schedule the desired services.

Various embodiments of the invention have been described. For example, a client management system 50 and associated processes have been described. However, one skilled in the art will recognize that various modifications may be made to the described embodiments without departing from the scope of the invention.

For example, the invention may also be embodied in a computer-readable medium comprising instructions that cause a programmable processor to perform functions attributed to the components of a client management system herein. The computer-readable medium may comprise any magnetic, optical, or electrical media, such as a random access memory (RAM), read-only memory (ROM), CD-ROM, hard disk, electrically-erasable programmable ROM (EEPROM), flash memory, or the like.

As another example, a single device, such as a computer or workstation, may provide the functionality of both the intake workstation and the access workstation described herein. In such embodiments, access to intake functionality may be controlled by user name and password. Further, in some embodiments, varying degrees of access to the functionality provided by access workstations may be controlled by username and password. For example, access to the various modules 54-60 provided by an access workstation 44 may granted on a per-module basis.

Moreover, a client management system may include more than one network and more than one database. Further, a database may be stored within more than one memory, and managed by more than one device. In some embodiments, a client management system may include a web server, and the various screens described herein may be served to intake workstations 12 and access workstations 44 as web pages.

Although described herein as, in exemplary embodiments, being implemented via Lotus software applications and database platforms commercially available from International Business Machines Corp, the invention is not so limited. The invention may be realized through use of any suitable commercially available or custom-designed database platforms and software applications. These and other embodiments are within the scope of the following claims.

1. A method comprising:
reading a client credential card to identify a client of a social service organization;
retrieving data associated with the identified client from a database; and
determining whether the identified client is permitted to receive a service provided by the social service organization based on the retrieved data.

2. The method of claim 1, wherein the social service organization comprises at least one of a shelter, a domestic violence support provider, a state government, a country government, an information and referral agency, and a food shelf, and services provided by the social service organization include at least one of shelter, food, showers, medical care, counseling, employment assistance and housing assistance.

3. The method of claim 1, wherein determining whether the identified client is permitted to access a service comprises determining whether the retrieved data indicates a past incident pertaining to the client, the method further comprising generating a security advisory that suggests denial of the service to the identified client in the event the retrieved data indicates a past incident pertaining to the client.

4. The method of claim 1, wherein determining whether the identified client is permitted to receive a service comprises determining whether the identified client is permitted to access a facility of the social services organization.

5. The method of claim 1, further comprising identifying a service for delivery to the identified client based on the retrieved data.

6. The method of claim 1, further comprising identifying a housing opportunity for the identified client based on the retrieved data.

7. The method of claim 1, further comprising:
providing the service to the client; and
updating the database to reflect provision of the service to the client.

8. The method of claim 1, wherein reading a client credential card comprises reading a unique identification number associated with the client stored in machine-readable form on the client credential card, and wherein querying a database comprises providing the identification number to the database.

9. The method of claim 1, wherein at least a portion of the data is encoded onto one of a magnetic stripe, bar code, radio frequency identification tag, or smartcard chip that is carried by the card.

10. A client management system comprising:
a database to store data associated with a client of a social service organization;
a card reader to read a client credential card associated with the client; and
an access workstation coupled to the card reader to identify the client based on data read from the client credential card, retrieve at least some of the data associated with the client from the database, and to determine whether the client is permitted to receive a service provided by the social service organization based on the retrieved data.

11. The system of claim 10, wherein the social service organization comprises at least one of a shelter, a domestic violence support provider, a state government, a country government, an information and referral agency, and a food shelf, and services provided by the social service organization include at least one of shelter, food, showers, medical care, counseling, employment assistance and housing assistance.

12. The system of claim 10, wherein the access workstation retrieves the data from the database via a network.

13. The system of claim 10, wherein the access workstation includes an incident/observation module that determines whether the retrieved data indicates a past incident pertaining to the client and generates a security advisory that suggests denial of the service to the client in the event the retrieved data indicates a past incident pertaining to the client.

14. The system of claim 10, wherein the access workstation is located at a facility of the social services organization, and determines whether the client permitted to access the facility based on the retrieved data.

15. The system of claim 10, wherein the access workstation further comprises a housing module to identify housing opportunities for the identified client based on the retrieved data.

16. The system of claim 10, wherein the access workstation further comprises a services module to identify services for delivery to the identified client based on the retrieved data.

17. The system of claim 10, wherein the access workstation updates the database to reflect provision of the service to the client.

18. The system of claim 10, wherein data read from the client credential card includes a unique identification number associated with the client, and the access workstation retrieves the at least some data associated with the client from the database based on the unique identification number.

19. A computer-readable medium comprising instructions that cause a programmable processor to:
identify a client of a social service organization based on data read from a client credential card;
retrieve data associated with the identified client from a database; and
determine whether the identified client is permitted to receive a service provided by the social service organization based on the retrieved data.

20. The computer-readable medium of claim 19, wherein the instructions that cause a programmable processor to determine whether the identified client is permitted to receive a service comprise instructions that cause a programmable processor to determine whether the retrieved data indicates a past incident pertaining to the client, the medium further comprising instructions that cause a programmable processor to generate an advisory in the event the retrieved data indicates a past incident pertaining to the client.

21. The computer-readable medium of claim 19, further comprising instructions that cause a programmable processor to identify a service for delivery to the identified client based on the retrieved data.

22. The computer-readable medium of claim 19, further comprising instructions that cause a programmable processor to identify a housing opportunity for the identified client based on the retrieved data.

23. The computer-readable medium of claim 19, further comprising instructions that cause a programmable processor to update the database to reflect provision of the service to the client.

24. A method comprising
collecting data associated with clients of at least one social service organization, the data for each of the clients including identification data;
creating a record within a database for each of the clients, each of the records including at least some of the data collected for the respective client;
generating a client credential card for each of the clients, wherein each of the client credential cards includes at least a portion of the data for the respective client;
reading the client credential cards to identify clients when the clients attempt to receive services provided by the social service organization; and
updating the records within the database based on services received by the clients to track usage of the services by the clients.

25. The method of claim 24, wherein the social service organization comprises at least one of a shelter, a domestic violence support provider, a state government, a country government, an information and referral agency, and a food shelf, and services provided by the social service organization include at least one of shelter, food, showers, medical care, counseling, employment assistance and housing assistance.

26. The method of claim 24, further comprising storing data related to application for and usage of housing by the clients within respective records within the database.

27. The method of claim 24, further comprising storing data related to at least one of incidents and observations pertaining to the clients within respective records within the database.

28. The method of claim 24, further comprising storing demographic data for the clients within respective records within the database.

29. The method of claim 24, further comprising:
providing an interface for the user to search the records stored within the database;
receiving a query from the user via the interface; and
presenting a list including at least one the records based on the query

30. The method of claim 24, further comprising generating a report based on the data stored in the database for the plurality of clients.

31. The method of claim 30, further comprising receiving parameters from a user, wherein generating a report comprises filtering the data for inclusion in the report based on the parameters.

32. The method of claim 30, wherein the report comprises one of a turnstile report and a cost of services report.

33. A client management system comprising:
a database;
an intake workstation to collect data associated with clients of at least one social services organization, the data for each of the clients including identification data, create a record within the database for each of the clients, each of the records including at least some of the data collected for the respective client, and control a card printer to generate a client credential card for each of the clients, wherein each of the client credential cards includes at least a portion of the data for the respective client; and
an access workstation to read the client credential cards via a card reader to identify clients when the clients attempt to receive services provided by the social service organization, and update the records within the database based on social services accessed by the clients provided by the social service organization to track usage of the services by the clients.

34. The system of claim 33, wherein the social service organization comprises at least one of a shelter, a domestic violence support provider, a state government, a country government, an information and referral agency, and a food shelf, and services provided by the social service organization include at least one of shelter, food, showers, medical care, counseling, employment assistance and housing assistance.

35. The system of claim 33, wherein at least one of the intake workstation and the access workstation stores data related to application for and usage of housing by the clients within respective records within the database.

36. The system of claim 33, wherein the access workstation stores data related to at least one of incidents and observations pertaining to the clients within respective records within the database.

37. The system of claim 33, wherein the data collected for each of the clients includes demographic data.

38. The system of claim 33, wherein at least one of the intake workstation and the access workstation provides an interface for a user to search the records within the database, receives a query from the user via the interface, and presents a list including at least one of the records to the user via the interface based on the query.

39. The system of claim 33, wherein at least one of the intake workstation and the access workstation include a report generating module to generate a report based on the data stored in the database for the plurality of clients.

40. The system of claim 39, wherein the workstation receives parameters from a user via a user interface, and the report generating module filters the data for inclusion in the report based on the parameters.

41. The system of claim 39, wherein the report comprises one of a turnstile report and a cost of services report.

42. The system of claim 33, wherein the at least one of the intake workstation and the access workstation accesses the database via a network.
